(19) United States
(12) Patent Application Publication
(10) Pub. No.: US 2011/0185199 A1
(43) Pub. Date: Jul. 28, 2011

(54) EMBEDDED SYSTEM AND POWER SAVING METHOD THEREOF

(75) Inventors: KUO-SHU HUNG, Tu-Cheng (TW); CHIA-WEI LIAO, Tu-Cheng (TW)

(73) Assignee: HON HAI PRECISION INDUSTRY CO., LTD., Tu-Cheng (TW)

(21) Appl. No.: 12/732,199

(22) Filed: Mar. 26, 2010

(30) Foreign Application Priority Data
Jan. 28, 2010 (CN) 201020301798.0

(51) Int. Cl. G06F 1/32

(52) U.S. Cl. 713/310; 713/323

(57) ABSTRACT

An embedded system comprises a main chip generating a sleep signal, a network interface controller (MC) generating a wake-up signal, a microprogrammed control unit (MCU), a switch, and a power source. The MCU sends a closing signal upon receiving the wake-up signal and an opening signal upon receiving the sleep signal. The switch comprises a public terminal, a free terminal, and a control terminal. The free terminal connects to the main chip, the control terminal connects to the MCU, the public terminal connects to the free terminal upon receiving the closing signal, and the public terminal disconnects from the free terminal upon receiving the opening signal. The power source connects to the MC and the MCU to provide power, and further connects to the public terminal to provide power if the public terminal and the free terminal are connected, and stop power if disconnected.

### BACKGROUND

1. Technical Field

Embodiments of the present disclosure relate to electronic devices, and particularly to an embedded system for an electronic device.

2. Description of Related Art

Wake on LAN (WOL) is an Ethernet computer networking standard that allows a computer to be turned on or woken up by a network message. Often, an embedded system cannot perform the WOL as the computer, due to lack of a basic input and output system (BIOS). Therefore, the embedded system is designed to comprise a network interface controller (NIC) to act as the WOL of the computer. However, the resulting main chip with the NIC wastes power.

Therefore, it is desirable to provide an embedded system for power saving that addresses the described.

### BRIEF DESCRIPTION OF THE DRAWINGS

FIG. 1 is a block diagram of one exemplary embodiment of an embedded system of the present disclosure.

FIG. 2 depicts a flowchart of one exemplary embodiment of a method to save power applied in an embedded system of the present disclosure.

### DETAILED DESCRIPTION

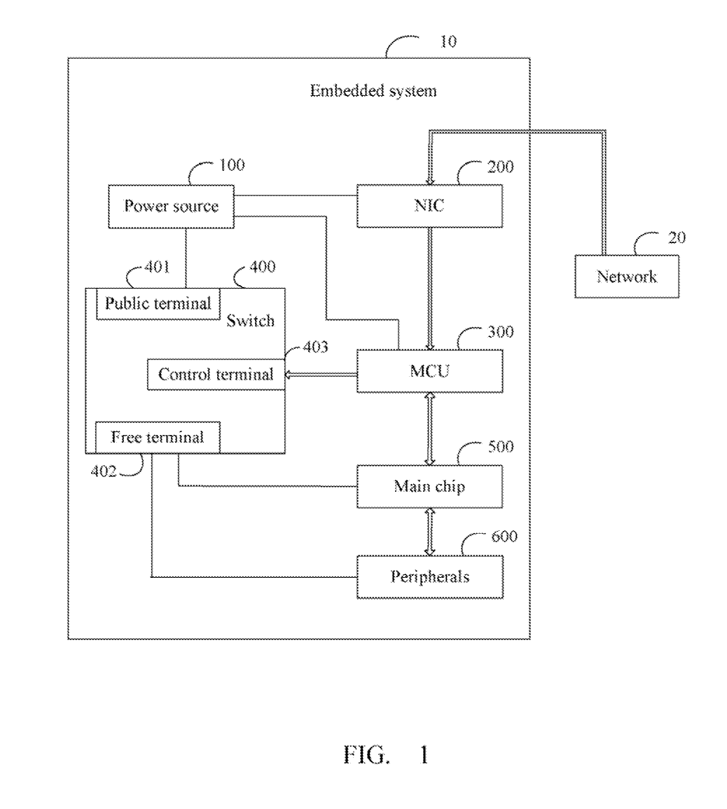

Referring to FIG. 1, a block diagram of one exemplary embodiment of an embedded system 10 is shown. Solid lines indicate power supply lines, and arrowed lines indicate data transmission lines. In one embodiment, the embedded system 10 comprises a power source 100, a network interface controller (NIC) 200, a microprogrammed control unit (MCU) 300, a switch 400, a main chip 500, and a plurality of peripherals 600. In one embodiment, the plurality of peripherals 600 refer to parts of the embedded system 10 can expand capabilities, while not forming a core architecture of the embedded system 10.

The main chip 500 generates a sleep signal when the embedded system 10 is idle. In one embodiment, the term “idle” refers to the embedded system 10 receiving no packets from a network 20 and no user input within a predefined time period.

The NIC 200 receives a magic packet from the network 20, and generates a wake-up signal accordingly. In one embodiment, the magic packet is a wake on LAN (WOL) packet.

The MCU 300 sends a closing signal to the switch 400 upon receiving the wake-up signal from the NIC 200, or an opening signal to the switch 400 upon receiving the sleep signal from the main chip 500. In one embodiment, the term “closing signal” refers to one control signal to close the switch 400, and the term “opening signal” refers to another control signal to open the switch 400. The MCU 300 may be a system on chip (SOC). In another embodiment, the MCU 300 may be a transistor.

The switch 400 comprises a public terminal 401, a free terminal 402, and a control terminal 403. In one embodiment, the public terminal 401 connects to the power source 100, the free terminal 402 connects to the main chip 500 and the plurality of peripherals 600, and the control terminal 403 connects to the MCU 300. In one embodiment, the public terminal 401 connects to the free terminal 402 if the control terminal 403 receives the closing signal from the MCU 300, and disconnects from the free terminal 402 if the control terminal 403 receives the opening signal from the MCU 300.

The power source 100 connects to the NIC 200 and the MCU 300, to provide power to the NIC 200 and the MCU 300. Furthermore, the power source 100 connects to the public terminal 401 of the switch 400. The power source 100 provides power to the main chip 500 and the plurality of peripherals 600 if the public terminal 401 connects to the free terminal 402, and stops providing power to the main chip 500 and the plurality of peripherals 600 if the public terminal 401 disconnects from the free terminal 402.

In one embodiment, the power source 100 provides power to the NIC 200 and the MCU 300, and stops providing power to the main chip 500 when the embedded system 10 is in the sleep mode, thereby saving power.

The plurality of peripherals 600 comprise a flash memory, and a double data rate synchronous dynamic random access memory (DDR SDRAM). In one embodiment, the plurality of peripherals 600 exchange data with the main chip 500, and receive power from the power source 100 via the switch 400.

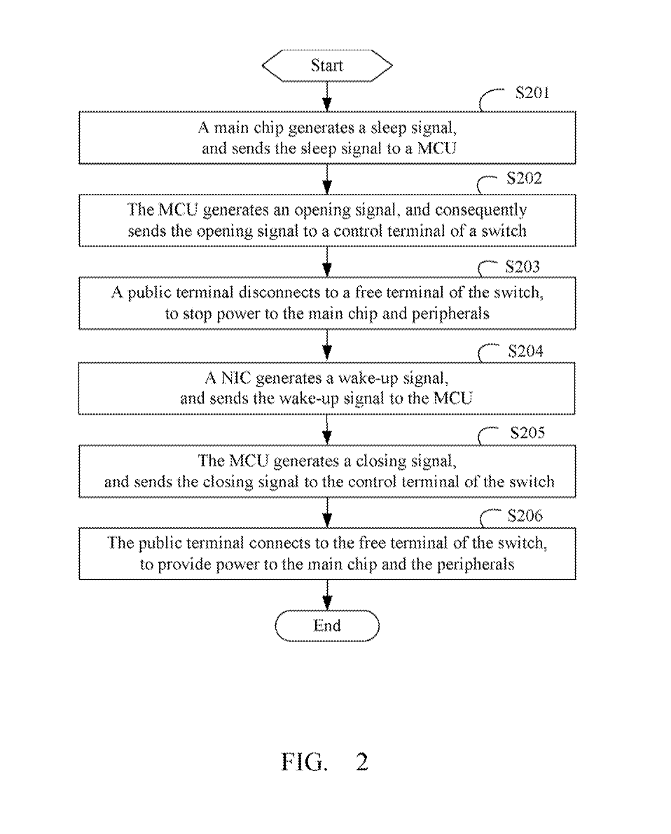

Referring to FIG. 2, a flowchart of one exemplary embodiment of a method to save power applied in the embedded system is shown. In one embodiment, blocks S201-S203 describe operations in a sleep mode, and blocks S204-S206 describe operations in an operating mode.

In block S201, the main chip 500 generates a sleep signal, and sends the sleep signal to the MCU 300, when the embedded system 10 does not receive any packet from the network 20 or any instruction from a user within a predefined time period.

In block S202, the MCU 300 receives the sleep signal, and consequently sends an opening signal to the control terminal 403 of the switch 400.

In block S203, the public terminal 401 disconnects from the free terminal 402, when the control terminal 403 of the switch 400 receives the opening signal, and the power source 100 stops power to the main chip 500 and the plurality of peripherals 600, and the embedded system 10 enters the sleep mode.

In block S204, the NIC 200 receives a magic packet from the network 20, and consequently sends a wake-up signal to the MCU 300.

In block S205, the MCU 300 sends a closing signal to the control terminal 403 of the switch 400 upon receiving the wake-up signal.

In block S206, the public terminal 401 connects to the free terminal 402 when the control terminal 403 of the switch 400 receives the closing signal, the power source 100 provides power to the main chip 500 and the plurality of peripherals 600, and the embedded system 10 enters the operating mode.

In one embodiment, the embedded system 10 is designed to separate the NIC 200 from the main chip 500, so as to save power by stopping power to main chip 500 and the plurality of peripherals 600.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. An embedded system, comprising:
a main chip operable to generate a sleep signal when the embedded system is idle;
a network interface controller (NIC) operable to receive a magic packet and generate a wake-up signal according to the magic packet;
a microprogrammed control unit (MCU) operable to send a closing signal upon receiving the wake-up signal from the NIC, and send an opening signal upon receiving the sleep signal from the main chip;
a switch comprising a public terminal, a free terminal, and a control terminal, wherein the free terminal connects to the main chip, the control terminal connects to the MCU, and the public terminal connects to the free terminal if the control terminal receives the closing signal, or the public terminal disconnects from the free terminal if the control terminal receives the opening signal; and
a power source connecting to the NIC and the MCU operable to provide power thereto, and further connecting to the public terminal of the switch operable to provide power to the main chip if the public terminal connects to the free terminal, and stop providing power to the main chip if the public terminal disconnects from the free terminal.

2. The embedded system as claimed in claim 1, wherein the embedded system is considered idle when neither network packets nor user instructions are received within a predefined time period.

3. The embedded system as claimed in claim 1, further comprising a plurality of peripherals, connected to the free terminal of the switch.

4. The embedded system as claimed in claim 3, wherein the plurality of peripherals comprise a flash memory and a double data rate synchronous dynamic random access memory (DDR SDRAM).

5. The embedded system as claimed in claim 1, wherein the MCU is a selective one of a system on chip (SOC) and a transistor.

6. A power saving method for an embedded system, the embedded system comprising a power source, a network interface controller (NIC), a microprogrammed control unit (MCU), a switch, and a main chip, the power saving method comprising:
the main chip generating a sleep signal to the MCU, when the embedded system is idle;
the MCU receiving the sleep signal, and sending an opening signal to a control terminal of the switch;
a public terminal disconnecting from a free terminal of the switch if the control terminal receives the opening signal, and the power source stopping power to the main chip;
the NIC receiving a magic packet from the network, and sending a wake-up signal to the MCU;
the MCU sending a closing signal to the control terminal of the switch upon receiving the wake-up signal; and
the public terminal connecting to the free terminal of the switch if the control terminal receives the closing signal, and the power source providing power to the main chip, the embedded system in the operating mode.

7. The power saving method as claimed in claim 6, wherein the embedded system is considered idle when neither network packets nor user instructions are received within a predefined time period.

8. The power saving method as claimed in claim 6, the embedded system further comprising a plurality of peripherals, connected to the free terminal of the switch.

9. The power saving method as claimed in claim 8, wherein the plurality of peripherals comprise a flash memory and a double data rate synchronous dynamic random access memory (DDR SDRAM).

10. The power saving method as claimed in claim 6, wherein the MCU is a selective one of a system on chip (SOC) and a transistor.
